(19) United States
(12) Patent Application Publication
(10) Pub. No.: US 2016/0343045 A1
(43) Pub. Date: Nov. 24, 2016

(54) CONTENT DELIVERY SYSTEM, STORAGE MEDIUM STORING A PROGRAM FOR DELIVERING CONTENT, AND METHOD OF DELIVERING CONTENT

(71) Applicant: DENA CO., LTD, Tokyo (JP)

(72) Inventor: Yuji MAEDA, Tokyo (JP)

(21) Appl. No.: 15/114,614

(22) PCT Filed: Oct. 21, 2014
(86) PCT No.: PCT/JP2014/077922

§ 371 Date: Jul. 27, 2016

(30) Foreign Application Priority Data
Jan. 31, 2014 (JP) 2014-016782

(51) Int. Cl. G06Q 30/02; H04L 12/58; G06Q 50/00

(52) U.S. Cl. CPC G06Q 30/0282; G06Q 50/01; H04L 51/32

(57) ABSTRACT

Provided is a content delivery system, a program and a method for delivering content with which viewer users are encouraged to participate in a service. One embodiment of the invention include a reception unit that receives, from each of the client devices, first content evaluation information that represents an evaluation of a first content posted by a predetermined posting user, an evaluation unit that determines posting-user evaluation information that represents an evaluation of the predetermined posting user based on the first content evaluation information, a background image determination unit that determines a background image for the predetermined posting user based on the posting-user evaluation information, and a display control unit configured to cause each of the client devices to display a screen image that includes the background image and at least one or more contents including the first content posted by the predetermined posting user.

### CROSS-REFERENCE TO RELATED APPLICATIONS

This application is based on and claims the benefit of priority from Japanese Patent Application Serial No. 2014-016782 (filed on Jan. 31, 2014), the contents of which are hereby incorporated by reference in their entirety.

### TECHNICAL FIELD

The present disclosure relates to a content delivery system and a program and a method for delivering content, and in particular to enhancement of display of a background image shown on client devices at the time of content delivery

### BACKGROUND

A content sharing system that distributes contents such as a posted live-performance video to many users is commercially available. As an example of a service capable of delivering live-performance videos, USTREAM provided by Ustream, Inc. has been known. These kind of content sharing services typically provide client devices with a screen image that includes a content display region for displaying a content and a background region for displaying information other than the content.

In the background region, a background image is shown and an avatar image(s) of a viewer user(s) and a message(s) from a viewer user(s) superimposed on the background image are also shown. In this manner, the content sharing services provide users with virtual community spaces in which users can communicate via avatars and messages on screens. As describes above, users are able to not only view contents but also to participate a content sharing service by using avatars and sending messages.

### RELEVANT REFERENCES

### List of Relevant Patent Literature

Patent Literature 1: Japanese Patent Application Publication No. 2012-118919

### SUMMARY

A content delivery platform may implement such avatar and message features in order to encourage viewer users to actively participate in a content sharing service (or a community space which the service provides) provided by the plat form. However, when it comes to background images, a feature to encourage the viewer users' participation provided thereon has not been known. Patent Literature 1 only shows background images according to the theme (“theater,”live performance” and the like) specified by a user who posted a content. In short, a background image included in a screen image of a content is conventionally set by a user who posted the content or a content delivery platform.

As more users participate or involve in a content sharing service, an entertainment aspect of the service can be enhanced so that it is important to improve a system to encourage users to participate in the service. Therefore it is desired to enhance a background image on the screen to be one that encourages users to participate in the service, in addition to the avatar and message features. In view of the above, one object of the present invention is to provide a content delivery system, a program and method for delivering a content with which viewer users are encouraged to participate in a service. Other objects of the invention will be apparent with reference to the entire description in this specification.

One embodiment of the invention relates to system that includes one or more computer processors configured to execute a computer program to deliver a content to a plurality of client devices. A computer program according to one embodiment may include a reception module that receives, from each of the client devices, first content evaluation information that represents an evaluation of a first content posted by a predetermined posting user, an evaluation module that determines posting-user evaluation information representing an evaluation of the predetermined posting user based on the first content evaluation information, a background image determination module that determines a background image for the predetermined posting user based on the posting-user evaluation information, and a display control module configured to cause each of the client devices to display a screen image that includes at least one or more contents including the first content posted by the predetermined posting user and the background image. As will be apparent from the description, a system according to one embodiment of the invention may cause one or more computer processors to execute the above-described and following modules: a reception unit that receives, from each of client devices, first content evaluation information that represents an evaluation of a first content posted by a predetermined posting user; an evaluation unit that determines posting-user evaluation information that represents an evaluation of the predetermined posting user based on the first content evaluation information; a background image determination module that determines a background image for the predetermined posting user based on the posting-user evaluation information; and a display control module configured to cause each of the client devices to display a screen image that includes at least one or more contents including the first content posted by the predetermined posting user and the background image.

According to the system of the embodiment, since a background image for the posting user of a content is determined based on an evaluation of the content made by users, a new way to participate in the service can be provided to the users such that the evaluations of the content by the users determine the background image for the posting user. In this way, users may not only watch the content but also participate in the content sharing service by rating the content which the users watch.

In one embodiment where more than one content (a first content and a second content) are posted by a predetermined posting user, the posting-user evaluation information that represents an evaluation of the predetermined posting user may be determined based on first content evaluation information of the first content and second content evaluation information of the second content.

In one embodiment, a screen image may be configured to further include an image of an item specified based on the content evaluation information. In this embodiment, it is possible to further encourage users to participate in the service by showing not only a background image of a content but also an item that corresponds to an evaluation of the content on the screen.

The content in one embodiment may be a live-performance content. The screen image in one embodiment may include a first display region where the live-performance content is displayed and a second display region where the background image is displayed. The reception module according to one embodiment is configured to receive the content evaluation information only while the live-performance content is being delivered and displayed in the first display region. In this way, it is possible to determine the posting-user evaluation information based on content evaluation information provided by users who are actually viewing the content.

Another embodiment of the invention relates to a computer program for delivering contents posted by a plurality of posting-users to each of a plurality of client devices. The computer program according to the embodiment causes one or more computer processors to serve as: a reception module receiving, from each of the client devices, first content evaluation information that represents an evaluation of a first content posted by a predetermined posting user; an evaluation module determining posting-user evaluation information that represents an evaluation of the predetermined posting user based on the first content evaluation information; a background image determination module determining a background image for the predetermined posting user based on the posting-user evaluation information; and a display control module configured to cause each of the client devices to display a screen image that includes the background image and at least one or more contents including the first content posted by the predetermined posting user.

Another embodiment of the invention relates to a method of delivering contents posted by a plurality of posting-users to each of a plurality of client devices. A method of delivering a content to each of a plurality of client devices, comprising: receiving, from each of the client devices, first content evaluation information that represents an evaluation of a first content posted by a predetermined posting user; determining posting-user evaluation information that represents an evaluation of the predetermined posting user based on the first content evaluation information; determining a background image for the predetermined posting user based on the posting-user evaluation information; and causing each of the client devices to display a screen image that includes the background image and at least one or more contents including the first content posted by the predetermined posting user.

In view of the above, one object of the present invention is to provide a content delivery system, a program and method for delivering a content with which viewer users are encouraged to participate in a service.

### BRIEF DESCRIPTION OF THE DRAWINGS

FIG. 1 is a block diagram schematically illustrating a content delivery system according to an embodiment of the invention.

FIG. 2 shows an example of a screen image management table according to the embodiment of the invention.

FIG. 3 shows an example of a view of a screen image according to the embodiment of the invention.

FIG. 4 shows an example of a view of a screen image according to the embodiment of the invention.

FIG. 5 is a flow diagram showing a process flow from start of viewing a content to determination of posting-user evaluation information.

FIG. 6 is a flow diagram showing a process flow from request of content delivery to display of a screen image including the content and a background image.

### DESCRIPTION OF THE PREFERRED EMBODIMENTS

Various embodiments of the invention will be described hereinafter with reference to the drawings. In the drawings, the same components are denoted by the same reference numerals.

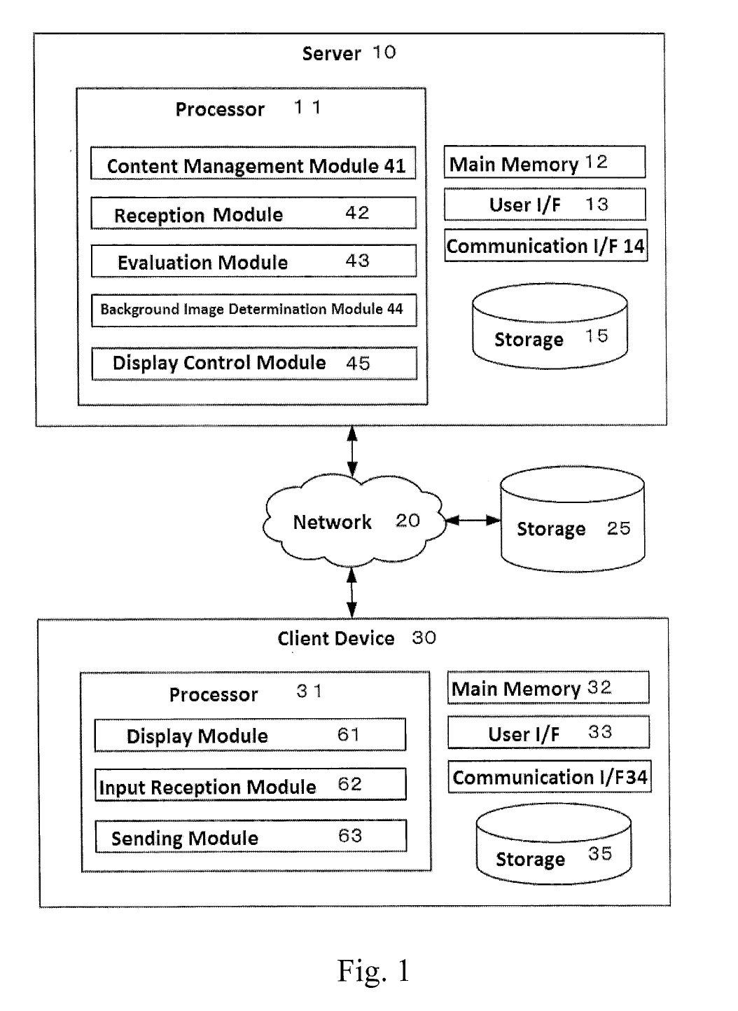

FIG. 1 is a block diagram schematically illustrating a system that includes a server 10 according to an embodiment of the invention. Referring to FIG. 1, the server 10 according to the embodiment is communicatively connected to a client device 30 via a network 20 such as the Internet. Although FIG. 1 shows only one client 30, the server 10 may be communicatively connected to a plurality of client devices 30.

The server 10 according to the embodiment may provide a content sharing service; for example, the server 10 may deliver posted contents such as a live-performance video to a client device 30 along with other information necessary to provide the service. In the content sharing service, the server 10 allows posted contents such as a live-performance video to be openly shared by users of the service. A user may operate the client device 30 to access a desired one of the posted contents and can view the desired content. The server 10 may also provide features for displaying avatars, chatting and the like in order to encourage users to participate the content sharing service.

In response to a delivery request for a desired content from a client device 30, the server 10 may cause a screen image that includes the requested content to be displayed on the client device. The screen image to be displayed on the client device 30 may include a content display region for displaying a delivered content and a background region for displaying information other than the content. Avatars that represent viewer users and messages from viewer users may be shown in the background region. As will be described later, a viewer user can transmit information that indicates feedback for the content which the viewer user is watching to the server 10 via a user interface provided by the client device 30. The server 10 may rate the corresponding posting user who posted the content based on the feedback information for the content, and may determine a background image based on the information that indicates the rating of the posting user. In this way, a user may not only watch the content but participate the content sharing service by rating the content which the user watches.

Next, architecture of the server 10 according to an embodiment will be described. As shown, the server 10 according to the embodiment may include a processor 11, a main memory 12, a user I/F 13, a communication I/F 14, and a storage 15. These components may be electrically connected to each other via a bus not shown. The processor 11 may load an operating system and various programs for performing delivery of views and images that include contents into the main memory 12 from the storage 15, and may execute commands included in the loaded programs. The main memory 12 may be used to store a program to be executed by the processor 11, and may be formed of, for example, a dynamic random access memory (DRAM).

The user I/F 13 may include, for example, an information input device such as a keyboard or a mouse for accepting an input from an operator, and an information output device such as a liquid crystal display for outputting calculation results of the processor 11. The communication I/F 14 may be implemented as hardware, firmware, or communication software such as a transmission control protocol/Internet protocol (TCP/IP) driver or a point-to-point protocol (PPP) driver, or a combination thereof, and may be configured to be able to communicate with the client 30 via the network 20.

The storage 15 may be formed of, for example, a magnetic disk drive. The storage 15 may store various contents and background images to be delivered to the client terminals 30. The contents may be video contents such as live-performance videos and recorded videos; but the types of the contents applicable to the invention are not limited specifically. The contents may be stored respectively in a predetermined file format in accordance with the types of the contents. For example, a video may be stored in a known format such as WMV format or QuickTime format. In an embodiment of the invention, the storage 15 may store contents posted by general users and contents posted by content providers (e.g., professional singers or entertainment production offices) that have been authorized to post the contents by an administrator of the server 10. Quality of the contents delivered can be maintained by previously examining the posting users. Background images may be stored in, for example, GIF format.

The storage 15 may further store programs such as an operating system and various programs for delivering screen images that include contents. The storage 15 may also store various data such as messages posted by viewer users, items which viewer users purchased, and avatars of the viewer users, in association with the contents. The various data such as messages, items, and avatars associated with a predetermined content may be shown in the background region of the screen image for delivering the content. The various data that may be stored on the storage 15 may also be stored on separate storage (e.g., a storage 25) or a database server that is physically separate from the server 10.

In an embodiment of the invention, the server 10 may serve as a web server for communicating with the terminal devices 30 in HTTP to manage a web site including a plurality of hierarchical web pages. The web pages may include a top page for the service, a page for delivering contents, a page for setting accounts, a page for posting contents, and other various web pages related to the content sharing service. The server 10 may send the web pages (or the HTML data for displaying the web pages) constituting the web site to a client device 30 in response to a request from the client device 30.

In another embodiment of the invention, an application program may be executed on the client device 30 in an execution environment such as an OS or middleware, such that the application program and the server 10 may cooperate with each other to provide the content sharing service. The application program may be stored on, e.g., the storage 15 or the storage 25 and may be downloaded onto the client device 30 in response to a request from the client device 30. The application program may include, on execution on the client device 30, instruction sets for processing data provided by the server 10 and various data such as image data referred to when the instruction sets are executed.

Thus, the server 10 may manage a predetermined web site and deliver web pages constituting the web site in response to a request from the client device 30, thereby providing the content sharing service. In other embodiments, the server 10 may cooperate with an application program executed on the client device 30 to provide the content sharing service. The server 10 may also include additional functions for providing the content sharing service, such as a function for implementing a player authentication process and a user charging process, which will not be described in detail.

An architecture of the client device 30 will be now described. In an embodiment, the client device 30 may be a desired information processing device including an application execution environment for executing an application including a web browser. Non-limiting examples of the client device 30 may include mobile phones, smartphones, tablet devices, personal computers, electronic book readers, and game consoles.

As shown, the client terminal 30 according to an embodiment of the invention may include a processor 31, a main memory 32, a user interface (I/F) 33, a communication I/F 34, and a storage 35, and these components may be electrically connected to one another via an bus (not shown).

The processor 31 may load various programs such as an operating system into the main memory 32 from the storage 35, and may execute commands included in the loaded programs. The main memory 32 may be used to store a program to be executed by the processor 31, and may be formed of, for example, a dynamic random access memory (DRAM).

The user I/F 33 may include an information input device for receiving inputs from the user and an information output device for outputting an operation result of the processor 31; and the user I/F 33 may include a display device such as a liquid crystal display having a touch screen. The communication I/F 34 may be implemented as hardware, firmware, or communication software such as a transmission control protocol/Internet protocol (TCP/IP) driver or a point-to-point protocol (PPP) driver, or a combination thereof, and may be configured to be able to communicate with the server 10 via the network 20.

The storage 35 may comprise, for example, a magnetic disk drive or a flash memory and store various programs such as an operating system. When receiving an application program from the server 10 via the communication I/F 34, the storage 35 may store the received application program.

The client 30 may include, for example, browser software for interpreting an HTML file (HTML data) and rendering a screen; this browser software may enable the terminal device 30 to interpret the HTML data fetched from the server 10 and render web pages corresponding to the received HTML data. Further, the client 30 may include plug-in software (e.g., Flash Player distributed by Adobe Systems Incorporated) embedded into browser software; therefore, the terminal device 30 can fetch from the server 10 a SWF file embedded in HTML data and execute the SWF file by using the browser software and the plug-in software.

When the HTML data contains a script, the browser software may execute the script and perform a process in accordance with the instruction of the script. For example, if the script in the HTML data refers to a file of the content stored on the storage 15 of the server 10, the browser software may fetch the file that has been referred to from the server 10 and embed the fetched content into the web page for rendering.

The web page fetched from the server 10 may include information indicating a list of contents that can be delivered from the server 10. A user may operate the client device 30 to select a desired content from the list and watch the selected content on the client device 30.

In the client terminal 30, the application program may be launched in accordance with the operation by the player and executed on a platform implemented on the client device 30. When the application program is executed on the client 30, for example, the application program may communicate with the server 10 and fetch information necessary for the content sharing service, such as information indicating a list of contents that can be delivered. In the case of using this application, similar to the case of using the web page, a user may operate the client device 30 to select a desired content from the list and view the selected content on the client device 30. As described above, the user of the client device 30 can receive a desired content delivered from the server 10 and can receive other various services included in the content sharing service.

The functions implemented by the computer program modules executed on the server 10 and the client device 30 will be now described. The processor 11 of the server 10 according to one embodiment and the processor 31 of the client device 30 may execute various computer program modules so as to implement the content sharing service provided to the user of the client device 30.

As shown in FIG. 1, computer program modules executed by the processor 11 of the server 10 may include a content management module 41, a reception module 42, an evaluation module 43, a background image determination module 44, and a display control module 45. The computer program modules executed by the processor 31 of the client device 30 may include a display module 61, an input receiving module 62, and a sending module 63.

A part or all of the modules provided to the server 10 shown in FIG. 1 may also be executed by the processor 31 of the client device 30 or a processor of other devices; and a part or all of the modules provided to the client device 30 may also be executed by the processor 11 of the server 10 or a processor of other devices. For example, when a storage that store contents is provided on a server other than the server 10, the content management module may also be provided on the other server.

The computer program modules executed by the processor 11 of the server 10 will be now described. The content management module 41 according to an embodiment may store, on the storage 15, a content posted by a posting user in such a manner that the content can be delivered to client devices 30. Upon posting of a content, the content management module 41 according to an embodiment may issue a content ID that identifies the content and store the content ID in a predetermined posting user management database in association with the posting user ID that specifies the posting user of the content.

The reception module 42 according to an embodiment may receive content evaluation information that indicates an evaluation result for a content from the client device 30 to which the content has been delivered. The content evaluation information may be, for example, five-level rating information. In response to an user's operation on the client device 30, a dialog screen for inputting the content evaluation information may be shown on the client device 30 that is displaying the content. The user may select any rating from the five-level rating (for example, five-point scale of “1 point,”“2 points,”“3 points,”“4 poinls,” and “5 points”) on the dialog screen. The client device 30 may generate rating information that indicates the evaluation made by the user who selected rating. The generated rating information may be transmitted to the server 10 from the client device 30. Once the reception module 42 according to one embodiment received the rating information from the client device 30, an evaluation point corresponding to the rating information may be determined. In the specification, information used for determining the evaluation point that indicates rating for a predetermined content may be referred to as content evaluation information. When the content viewed on the client device 30 is a live-performance content, the reception module 42 according to the embodiment may be configured to receive the content evaluation information only while the live-content is streamed.

In one embodiment of the invention, a user may allow to provide the content evaluation information to the server 10 when the user purchases a predetermined item while the user watches a predetermined content. For example, when a user views a predetermined content on the client device 30 and wishes to send a positive evaluation of the predetermined content, the user may purchase a predetermined item (hereunder may be referred to as an “evaluation item”) that is displayed in the background region of the screen image that includes the predetermined content. The evaluation item may be, for example, an item representing a bundle of flowers. The positive evaluation of the content may be presented to viewer users when such an item representing the flowers is shown on the screen image together with the content. When the reception module 42 received a request to purchase an evaluation item from the client device 30, the reception module 42 according to one embodiment may determine the evaluation point (for example, five-level rating information) for the evaluation item to be purchased In this embodiment, the evaluation point is determined based on the request to purchase the evaluation item so that the request to purchase the evaluation item or information that is specified by the request and represents the evaluation item may be the content evaluation information.

In some embodiments of the invention, when a user posts an article concerning a content in a social networking service such as “Facebook™” and “Twitter™” while viewing the content, the content evaluation information about the content may be provided to the server 10. For example, once a user selected a button that is displayed on the viewing screen for posting in a social networking service, a site of the social networking service may appear and the user can post a comment on the viewing content in the social networking site. When the button for posting in the social networking site is selected, the client device 30 may transmit, to the server 10, the content ID specifying the content which the user is viewing and information specifying the social networking site that corresponds to the selected button. When the reception module 42 according to one embodiment received the information that specifies the social networking site from the client device 30, the module may determine an evaluation point (for instance “3 points”) in accordance with a prescribed logic. In this embodiment, the evaluation point is determined based on the information that specifies the social networking site when the user posted in the social networking site, and therefore the information that specifies the social networking site may be the content evaluation information. For a user, when to post an article concerning a predetermined content in a social networking service is not limited to while the user is viewing the content. Moreover, what to write about the predetermined content may not be limited to a comment on the content but may be a recommendation of the content. For example, by posting “I am viewing content A,” the user can introduce the “content A” to other users in the social network.

In some embodiments of the invention, a user may transmit an invitation message for inviting other user(s) to view a predetermined content while the user is viewing the content. When the reception module 42 according to one embodiment received the invitation message from the client device 30, the module may determine an evaluation point (for instance, “5 points”) in accordance with a prescribed logic. In this embodiment, the evaluation point is determined based on the invitation message for other user(s) so that the invitation message may be the content evaluation information,

In some embodiments of the invention, a user may post a comment on a content while the user is viewing the content via a comment field displayed on the viewing screen of the content. The posted comment may be displayed on, for example, a part of the viewing screen of the content (preferably on an area of viewing screen where does not overlap with the content) and in this manner viewer users can communicate with each other through the comment. When the reception module 42 according to one embodiment received a comment display request to display a predetermined comment from the client device 30, the module may determine an evaluation point (for instance, “2 points”) in accordance with a prescribed logic. The reception module 42 may analyze the content of the comment which the user wishes to post and a higher evaluation point may be imparted when the comment contains a positive message (for example, the term “like”) for the content which the user is viewing. In this embodiment, the comment display request to display comment on a content which the user is viewing or texts included in the comment may be the content evaluation information.

In other embodiments of the invention, a user may cast a vote for one among prescribed voting objects displayed on the viewing screen of a content when the user is viewing the content. Progress and a result of the vote may be displayed on a part of the viewing screen of the content (preferably on an area of viewing screen where does not overlap with the content) and in this manner the posting user can communicate with viewing users through the vote. When the reception module 42 according to the embodiment received a voting request to cast a vote from the client device 30, the module may determine an evaluation point (for instance, “2 points”) in accordance with a prescribed logic. The reception module 42 may analyze the votes and may impart an evaluation points depending on the number of votes casted. In this embodiment, the voting request to cast a vote concerning the content which the user is viewing or the number of votes casted may be the content evaluation information.

In some embodiments, a plurality of contents which relate to each other may be provided. For instance, like variety shows and drama series on television program, contents labeled with a specific content name (program name) may be distributed weekly in the same time window (for example, 9 pm to 10 pm on every Monday). As an example, the contents titled “content A” may be distributed weekly at a set time. The contents that have the same content name and are delivered as a series (the content of each of the contents is different from each other) may be herein referred to as “regular contents.” A regular content provided at a certain point in time and a regular content provided at a different point in time may have a different content from each other but have the same content name and the identical content ID. Just like watching a weekly television program, a user can regularly view such a regular content. When the reception module 42 according to the embodiment received a request to view a regular content from a user, the module 42 may check the number of views of the regular contents based on viewing history information that indicates the viewing history of the user, and may determine an evaluation point based on the number of views. For example, the reception module 42 may impart a higher evaluation point for a larger number of views. In this embodiment, the request to view a regular content or the information that indicates the number of views of regular contents may be the content evaluation information.

The evaluation module 43 according to one embodiment of the invention may determine, based on the content evaluation information received by the reception module 42, posting-user evaluation information for each of the content posting users managed in the content management module 41. The determined posting-user evaluation information for each posting user may be stored in a predetermined evaluation information management database. The posting-user evaluation information for a specific posting user may be, for example, a sum total of the content value information (evaluation points) which has been imparted to the content that the posting user posted. For example, when the reception module 42 received content evaluation information of a predetermined content, the evaluation module 43 may refer to the above-mentioned posting user management database to specify the posting user who posted the predetermined content. The evaluation module 43 may then refer to the evaluation information management database to retrieve accumulated posting-user evaluation information (accumulated evaluation points) for the specified posting user. New posting-user evaluation information may be generated by adding the content evaluation information that is received by the reception module 42 to the accumulated posting-user evaluation information that has been reirieved. The newly-generated posting-user evaluation information may be then stored on the evaluation information management database. For instance, when the content evaluation information received by the reception module 42 may be “4 points” and the accumulated posting-user evaluation information stored on the evaluation information management database may be “120 points,” the sum of these points, “124 points” may be stored as the new posting-user evaluation information (evaluation points) on the evaluation information management database.

In one embodiment of the invention, when the reception module 42 received a request to purchase an evaluation item, content evaluation information may be determined for the evaluation item. In this case, the evaluation module 43 may determine new posting-user evaluation information based on the content evaluation information that has been determined based on the purchased item and the accumulated posting-user evaluation information that is stored on the evaluation information management database. The newly generated posting-user evaluation information may be then stored on the evaluation information management database. The content evaluation information for evaluation items may be determined depending on types of the items. For example, one type of the evaluation items may be a bouquet which is associated with the content evaluation information “1 point,” another type of the evaluation items may be a “cake” which is associated with the content evaluation information “3 points.” The correspondences between the evaluation items and the content evaluation information are not limited to the ones specifically described herein but may be determined in any way within the spirit and scope of the invention.

A single posting-user may post more than one content. In this case, a plurality of IDs each correspond to each of contents that the posting user posted (for instance, a first content and a second content), and the plurality of IDs may be managed in association with ID of the posting user in the posting-user management database. In this case, the posting-user evaluation information of the posting user who posited the plurality of contents may be determined based on content evaluation information for the first content and content evaluation information for the second content. More specifically, the posting-user information of the posting user may be determined based on content evaluation information of the first content when the reception module 42 received the content evaluation information of the first content, and the posting-user information of the posting user may be determined based on content evaluation information of the second content when the reception module 42 received the content evaluation information of the second content.

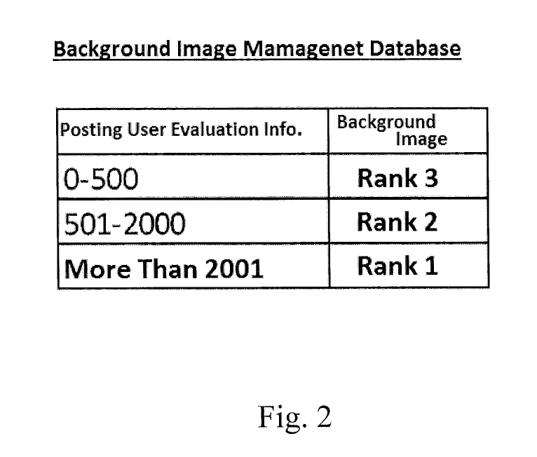

The background image determination module 44 according to one embodiment may determine a background image for each posting user based on the posting-user evaluation information that has been determined for each posting user by the evaluation module 43. The background image determination module 44 may use, for example, a background image management table illustrated in FIG. 2 to manage categories of background images in association with values of the posting-user evaluation information (the categories may be “rank 1,” “rank 2,” and “rank 3” in FIG. 2). For example, one or more background images (background image file(s)) may be stored in association with each category of the background images on the storage 15. Background image(s) for rank 1 or rank 3 may be arbitrarily determined but it is preferable that background images for a higher rank (rank closer to rank 1) be images that make the content more attractive (for instance, more gorgeous, elaborated and beautiful image(s)). For example, a view of a street may be set as an image in the category of rank 3, a view of a small live music club may be set as an image in the category of rank 2, and a view of a large arena may be set as an image in the category of rank 1. As another example, a view of a small art gallery may be set as an image in the category of rank 3, a view of a small art museum may be set as an image in the category of rank 2, and a view of a large art museum may be set as an image in the category of rank 3. In one embodiment of the invention, background images that belong to different categories may partially have a common feature. For example, background images that fall into different categories from each other may be created respectively by superimposing an object which may be different in each rank on the common image. For instance, background images that fall into different categories from each other may commonly have the same view of a live music club but a higher ranked image among them may include more attractive object for users.

In the embodiment illustrated in FIG. 2, the background image determination module 44 according to one embodiment may determine a background image for a predetermined content in response to a request to deliver the predetermined content. The background image determination module 44 may specify positing-user evaluation information of the posting user who posited the requested content based on the evaluation information management database. The background image determination module 44 may then refer the background image management table to determine the category in which a background image corresponding to the specified posting-user evaluation information falls. The background image determination module 44 may finally select one image from one or more background images stored in association with the specified category. In this manner, the background image determination module 44 according to one embodiment may determine a background image for the content based on the evaluation of the posting user of the content. In the embodiment, the higher the posting-user evaluation information, more attractive background image is selected for the content of the posting user. Therefore, like the real world in which a musician or performer who receives a higher evaluation is allowed to perform on a fantastic stage which would more easily attract audiences, more attractive background image may be provided for a content of a posting user with a higher evaluation.

In response to a delivery request for a particular content from the client device 30, the display control module 45 according to an embodiment may cause the client device 30 to display an image of screen that includes the requested content and the background image. More specifically, upon receiving a delivery request for a content, the display control module 45 according to an embodiment may retrieve, from the storage 15, the content that is specified by the delivery request. Then, the display control module 45 may cause the client device 30 that has transmitted the delivery request to display a screen image. In the screen image, the content retrieved from the storage 15 is shown in the content display region and a background image is shown in the background region. The background image has been determined by the background image determination module 44 based on the posting-user evaluation information of the posting user who posted the content. The display control module 45 may generate HTML data which may specify by the EMBED tag the URI that indicates the storage site of the requested content, and specify by the body element the URI that indicates the storage site of the image file of the background image that has been determined based on the posting-user evaluation information. Then, the display control module 45 may send the HTML data to the client device 30 and the client device 30 can display an image of screen that includes the requested content and the background image that has been determined based on the posting-user evaluation information.

In one embodiment of the invention, the display module 61 of the client device 30 may display the screen image that includes the content and the background image on the display of the client device 30 (or a display of an external device), in accordance with the control by the display control module 45 of the server 10. For example, the display module 61 may analyze the HTML data received from the display control module 45, obtain the content and the background image that are specified by the HTML data, display the obtained content in the content display region, and display the obtained background image as a background image of the screen.

The input receiving module 62 according to one embodiment of the invention may receive various instructions from a user. The user of the client device 30 may perform a prescribed operation (e.g., tap or double tap) on a region of a touchscreen of the client device 30 where an operation object (e.g., an operation button) is displayed in order to input an instruction associated with the object. The instruction from the user may include an instruction to perform evaluation of the content which the user is viewing and transmit content evaluation information corresponding to the evaluation to the server.

The messages indicating various instructions from the player received by the reception module 62 may be sent to the server 10 via the network 20 by the sending module 63 according to an embodiment of the invention. As stated above, the server 10 may perform various processes including calculation of the posting-user evaluation information based on the received messages as described above.

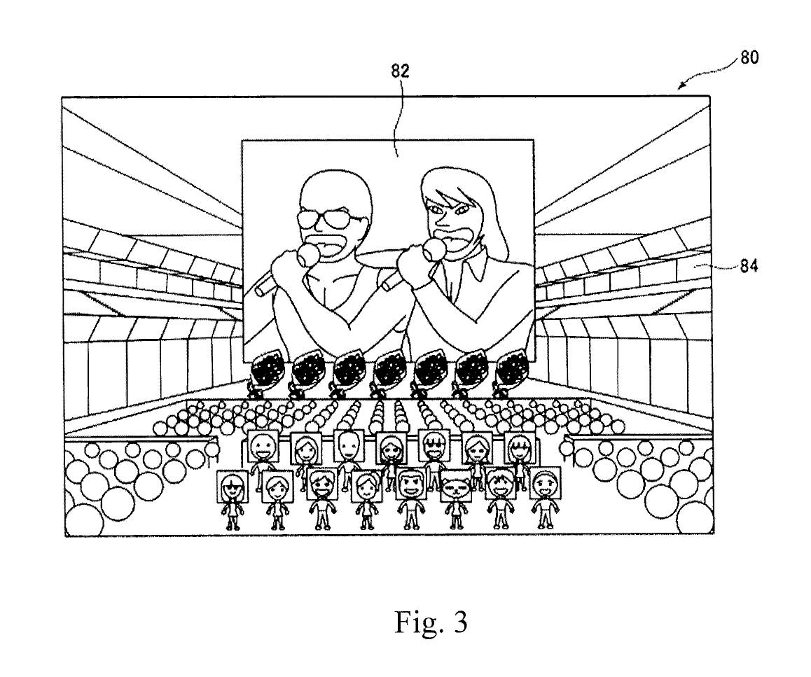

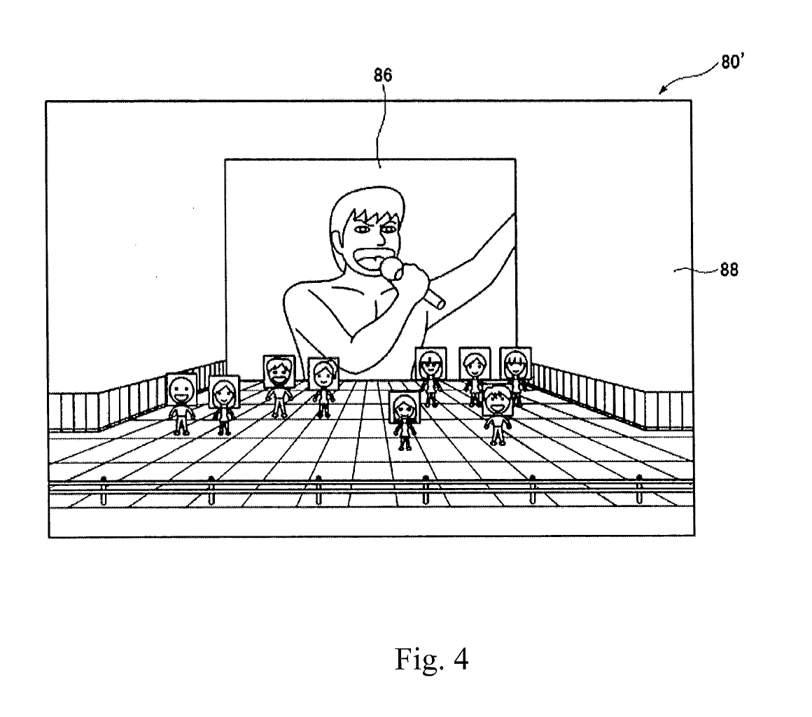

Examples of the screen image displayed on the client device 30 according to one embodiment of the invention are illustrated in FIGS. 3 and 4. FIGS. 3 and 4 show examples of the screen image displayed on the display of the client device 30 according to an embodiment of the invention. A screen image 80 of FIG. 3 may include a live-performance video 82, which is the content that the client device 30 requested to deliver thereto, and a background image 84 determined based on posting-user information of the posting user who posited the live-performance video 82. A screen image 80′ illustrated in FIG. 4 may include a live-performance video 86 which is posted by a posting user different from the posting user who posted the video of FIG. 3, and a background image 88 determined based on posting-user information of the posting user who posited the live-performance video 86. In this way, when the posting user who posted a content displayed on the client device 30 changes, the background image of the screen may change. When the evaluation of the posting user who posted the live-performance video 82 changes depending on the content evaluation information from viewer users, a new background image different from the background image 84 of FIG. 3 may be displayed. The same applies to the background image 88 of FIG. 4.

The screen image that includes a predetermined content displayed on the client device 30 may include an evaluation information object (for instance, a circular or bar indicator) that represents the posting-user evaluation information of the posting user of the predetermined content. The evaluation information object may include a current status of posting-user evaluation information of the posting user who posted the content and a value of posting-user evaluation information which is required to display a background image of a next higher rank. For example, as illustrated in FIG. 2, 500 or more points of the posting-user evaluation information may be required to display a background image in rank 2. More specifically, when a background image in rank 3 is displayed, the evaluation information object may indicate that at least 500 points are necessary to display a background image in the next rank. Moreover, if the current posting-user evaluation information is 200 points, the evaluation information object may show the current status of the evaluation information, which is 200 points, and the information to notify the user that 300 points (500 points-200 points) are necessary to display a background image in the next rank.

In the screen image that includes a predetermined content and is displayed on the client device 30, a contribution user information object that shows information about users who provided content evaluation information for the predetermined content may be displayed in association with or independently from the evaluation information object. The contribution user information object associated with a predetermined content may include a list of users who provided content evaluation information for the predetermined content, profile information of each of the users, evaluation points provided by each of the users, a contribution ranking in which the users are ranked depending on the evaluation points that the users provided for the content, and contents of the content evaluation information (for example, comment which a user posted, a content of a purchased evaluation item, and the like) which each user provided. The contribution user information object associated with a predetermined content may further include various information about the users who provided the content evaluation information of the predetermined content. The specific example described above is a merely example and the contribution user information object may include various types of information.

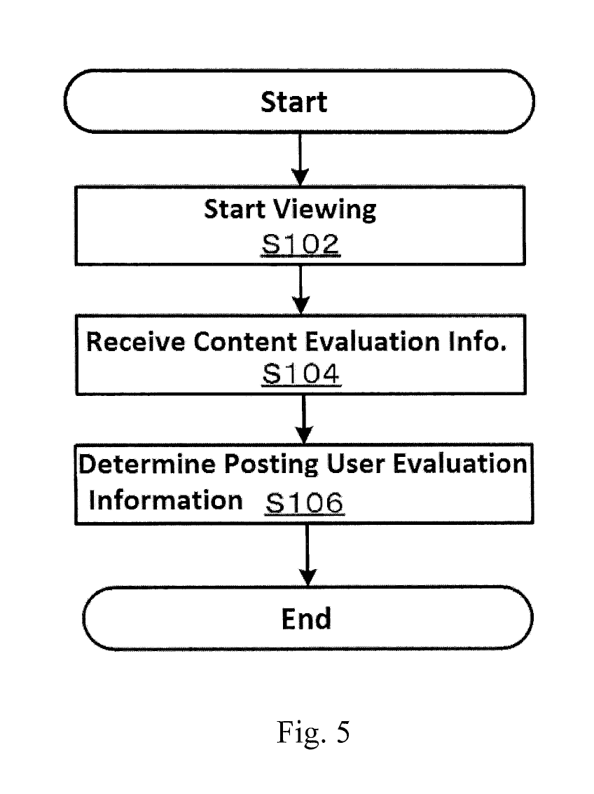

A process flow from start of viewing a content to determination of the posting-user evaluation information will be now described with reference to FIG. 5. First, in step S102, a user of a client device may access a server that provides a content sharing service and start viewing a desired content. On the client device, displayed is a screen image that includes the content which the user requested and a background image such as the ones illustrated in FIGS. 3 and 4.

In step S104, when a user inputs an evaluation of the content that the user is viewing on the client device, content evaluation information that represents the evaluation made by the user may be transmitted to the server from the client device. The server receives the content evaluation information. The reception process of the content evaluation information may be performed by, for example, the above-described reception module 42,

In step S106, posting-user evaluation information for the posting user who posited the content may be determined based on the content evaluation information of the viewing content that was received in step S104. The process to determine the posting-user evaluation information may be carried out by, for example, the above-described evaluation module 43. As described above, the posting-user evaluation information for the posting user who posted the content is determined based on the content evaluation information transmitted from the client device on which the content is viewed. The determined posting-user evaluation information may be stored on, for example, the above-described evaluation information management database. The posting-user evaluation information stored on the evaluation information management database may be updated each time the server receives content evaluation information from a client device. In this way, the posting-user evaluation information for the posting user of the content may be determined.

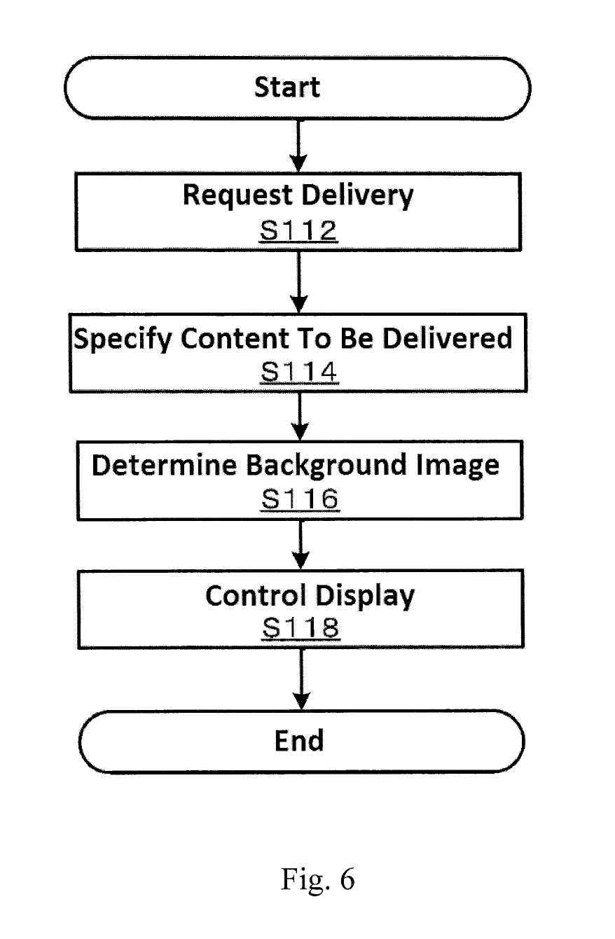

A process flow from request of content delivery to display of a screen image that includes the content and a background image according to one embodiment will be now described with reference to FIG. 6. First, in step S112, a client device may transmit a request to deliver a predetermined content to a server that provides a content sharing service. In step S114, a content corresponding to the delivery request from the client device may be specified. In step S116, posting-user evaluation information of the posting user who posited the requested content may be retrieved and a background image may be specified based on the posting-user evaluation information. The background image may be specified by, for example, the above-described background image determination module. In step S118, the client device that sent the content delivery request is caused to display a screen image that includes the content specified in step S114 in the content display region and the background image specified in step S116 in the background region. The process to display the screen image may be performed by, for example, the above-described display control module 45.

As described above, according to various embodiments of the invention, users make evaluations of a content and an evaluation of the posting user who posited the content is determined based on the users' evaluation. A background image for the posting user is determined based on the posting-user evaluation information that represents the evaluation of the posting user. In this way, it is possible to encourage viewer users who view a content to participate the service by providing the evaluation information of the content.

Even if the processes and the procedures described herein are executed by a single apparatus, software piece, component, or module, such processes and procedures may also be executed by a plurality of apparatuses, software pieces, components, and/or modules. Even if the data, tables, or databases described herein are stored in a single memory, such data, tables, or databases may also be dispersed and stored in a plurality of memories included in a single apparatus or in a plurality of memories dispersed and arranged in a plurality of apparatuses. The elements of the software and the hardware described herein can be integrated into fewer constituent elements or can be decomposed into more constituent elements.

With respect to the use of substantially any plural and/or singular terms herein, those having skill in the art can translate from the plural to the singular and/or from the singular to the plural as is appropriate to the context.

The procedures described herein, particularly those described with a flowchart, are susceptible of omission of part of the steps constituting the procedure, adding steps not explicitly included in the steps constituting the procedure, and/or reordering the steps. The procedure subjected to such omission, addition, or reordering is also included in the scope of the present invention unless diverged from the purport of the present invention.

### LIST OF REFERENCE NUMBERS

10 server

11, 31 processor

15, 25, 35 storage

30 client device

41 content management module

42 reception module

43 evaluation module

44 background image determination module

45 display control module

61 display module

62 input reception module

63 sending module

1. A system comprising one or more computer processors configured to execute a computer program to deliver a content to a plurality of client devices,
wherein the computer program includes:
a reception module receiving, from each of the client devices, first content evaluation information that represents an evaluation of a first content posted by a predetermined posting user;
an evaluation module determining posting-user evaluation information that represents an evaluation of the predetermined posting user based on the first content evaluation information;
a background image determination module determining a background image for the predetermined posting user based on the posting-user evaluation information; and
a display control module configured to cause each of the client devices to display a screen image that includes the background image and at least one or more contents including the first content posted by the predetermined posting user.

2. The system of claim 1 wherein
the reception module further receives, from each of the client devices, second content evaluation information representing an evaluation of a second content that is posted by the predetermined posting user and different from the first content, and
the evaluation module determines posting-user evaluation information that represents an evaluation of the predetermined posting user based on the first content evaluation information and the second content evaluation information.

3. The system of claim 1 wherein,
the screen image further includes an image of an item specified based on the first content evaluation information.

4. The system of claim 1 wherein,
the first content is a live-performance content.

5. The system of claim 4, wherein
the reception module is configured to receive the first content evaluation information from a predetermined client device among the plurality of client devices only while the live-performance content is being delivered to the predetermined client device.

6. A storage medium storing a computer program for delivering a content to each of a plurality of client devices, the computer program causing one or more computer processors to execute the steps of:
receiving, from each of the client devices, first content evaluation information that represents an evaluation of a first content posted by a predetermined posting user;
determining posting-user evaluation information that represents an evaluation of the predetermined posting user based on the first content evaluation information;
determining a background image for the predetermined posting user based on the posting-user evaluation information; and
causing each of the client devices to display a screen image that includes at least one or more contents including the first content posted by the predetermined posting user and the background image.

7. A method of delivering a content to each of a plurality of client devices, comprising:
receiving, from each of the client devices, first content evaluation information that represents an evaluation of a first content posted by a predetermined posting user;
determining posting-user evaluation information that represents an evaluation of the predetermined posting user based on the first content evaluation information;
determining a background image for the predetermined posting user based on the posting-user evaluation information; and
causing each of the client devices to display a screen image that includes the background image and at least one or more contents including the first content posted by the predetermined posting user.
